(19) United States
(12) Patent Application Publication
(10) Pub. No.: US 2005/0057426 A1
(43) Pub. Date: Mar. 17, 2005

(54) Antenna switch structure for a mobile terminal of a wireless communication system

(76) Inventor: Grigory Itkin, Munich (DE)

Correspondence Address: MYERS BIGEL SIBLEY & SAJOVEC, PO BOX 37428, RALEIGH, NC, 27627, US

(21) Appl. No.: 10/921,671

(22) Filed: Aug. 19, 2004

(30) Foreign Application Priority Data
Aug. 25, 2003 (EP) 03019190.2

(51) Int. Cl. H01Q 3/24

(52) U.S. Cl. 343/876; 343/702

(57) ABSTRACT

An antenna switch structure is provided for use in a mobile communication terminal. A first transceiver is configured to process signals of a first frequency band. A second transceiver is configured to process signals of a second frequency band. A first antenna is configured to transmit and receive wireless signals of the first frequency band. A second antenna is configured to transmit and receive wireless signals of the second frequency band. A connector is configured to releasably connect to a third antenna. A first switch is configured to selectively connect the first transceiver to the first antenna or to the connector. A second switch is configured to selectively connect the second transceiver to the second antenna or to the connector.

### RELATED APPLICATION

This application claims priority under 35 U.S.C. § 119 to European Patent Application No. 03019190.2, filed on Aug. 25, 2003, in the European Patent Office, the disclosure of which is herein incorporated by reference in its entirety.

### FIELD OF THE INVENTION

The present invention generally relates to the field of wireless communication, and more particularly, to antennas and transceivers that may be used for wireless communication.

### BACKGROUND OF THE INVENTION

Mobile terminals for wireless communication are used in different communication standards such as global system for mobile communications (GSM), digital cellular system (DCS), and Universal Mobile Telecommunications System (UMTS). Each of these communication standards cover and use different frequency bands. For a mobile terminal to be used with different standards, it needs to be capable of transmitting, receiving and processing signals on different frequency bands.

Document WO 03/015301 A1 discloses a multiband antenna switch circuit including a diplexer connected to an antenna terminal for demultiplexing signals of different pass bands, a first and a second switch circuit for switching a high frequency signal and a low frequency signal demultiplexed by the diplexer to a plurality of transmission/reception terminals, and several filters in the antenna switch circuit.

Document US 2002/0068530 A1 discloses a communication system for communicating RF signals at a plurality of communication standards through a common antenna. The communication system includes a transmitter having transmitter outputs for generating transmit band signals in the transmit bands of each supported communication standard, and a receiver having receiver inputs for receiving receive band signals in the receive bands of each supported communication standard. Further, a plurality of switches either couple the transmitter output or the receiver input associated with a particular communication standard to the common antenna.

To use a common antenna for different communication standards, many filters, switches and multiplexing or demultiplexing devices may be needed to couple the receiver or transmitter to the common antenna. This may lead to an increase in insertion losses in each band and a decrease of the radiated efficiency.

### SUMMARY OF THE INVENTION

Some embodiments of the present invention provide an antenna switch structure for use in a mobile communication terminal. A first transceiver is configured to process signals of a first frequency band. A second transceiver is configured to process signals of a second frequency band. A first antenna is configured to transmit and receive wireless signals of the first frequency band. A second antenna is configured to transmit and receive wireless signals of the second frequency band. A connector is configured to releasably connect to a third antenna. A first switch is configured to selectively connect the first transceiver to the first antenna or to the connector. A second switch is configured to selectively connect the second transceiver to the second antenna or to the connector.

According to further embodiments of the present invention, the connector may be configured to releasably connect to the third antenna which can be at least partially external to the mobile terminal. The first switch may be directly connected between the first antenna and the first transceiver, and the second switch may be directly connected between the second antenna and the second transceiver. The first switch and the second switch may comprise low insertion loss switches.

According to further embodiments of the present invention, the antenna switch structure includes a connection sensor that is configured to detect when the third antenna is connected to the connector and to generate a connection indication signal based thereon. The connection sensor may include an inductor and a resistor connected to the connector, and the connection indication signal may be based on a voltage across the resistor.

According to further embodiments of the present invention, the first switch is configured to selectively connect the first transceiver to the first antenna or to the connector based on the connection indication signal, and the second switch is configured to selectively connect the second transceiver to the second antenna or to the connector based on the connection indication signal. The first switch may be configured to connect the first transceiver to the first antenna based on the connection indication signal indicating that the third antenna is not connected to the connector, and the second switch is configured to connect the second transceiver to the second antenna based on the connection indication signal indicating that the third antenna is not connected to the connector. The first switch may be configured to connect the first transceiver to the connector based on the connection indication signal indicating that the third antenna is connected to the connector, and the second switch is configured to connect the second transceiver to the connector based on the connection indication signal indicating that the third antenna is connected to the connector.

Some other embodiments of the present invention provide a mobile communication terminal 11 that includes first and second transceivers, first and second antennas, a connector, and first and second switches. The first transceiver is configured to process signals of a first frequency band. The second transceiver is configured to process signals of a second frequency band. The first antenna is configured to transmit and receive wireless signals of the first frequency band. The second antenna is configured to transmit and receive wireless signals of the second frequency band. The connector is configured to releasably connect a third antenna. The first switch is configured to selectively connect the first transceiver to the first antenna or to the connector. The second switch is configured to selectively connect the second transceiver to the second antenna or to the connector. The first antenna and the second antenna are remotely located from each other within the mobile communication terminal.

The antenna switch structure may, for example, be used in (i.e., implemented within) a transceiver portion(s) of a cellular mobile phone, and may be used in other communication terminals that are configured for wireless communications. By using more than one antenna, and with each antenna configured for different frequency bands, the antennas may be directly connected to associated transceivers. This may reduce loses between the antennas and the transceivers, may increase the radiation efficiency of transmitted signals, may increase isolation between communicated signals, may reduce interference effects the antennas and/or the transceivers, and/or may reduce the need for filtering of the communication signals.

### BRIEF DESCRIPTION OF THE DRAWINGS

FIG. 1 is a block diagram of an antenna switch structure in accordance with various embodiments of the present invention.

FIG. 2 is a block diagram of an antenna switch structure in accordance with various further embodiments of the present invention.

### DETAILED DESCRIPTION OF THE INVENTION

The present invention now will be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the term “and/or” includes any and all combinations of one or more of the associated listed items.

It will be understood that, although the terms first, second, etc. may be used herein to describe various elements, these elements should not be limited by these terms. These terms are only used to distinguish one element from another. Thus, a first element discussed below could be termed a second element without departing from the teachings of the present invention.

As used herein, “mobile communication terminal” includes, but is not limited to, a terminal that is configured to receive and/or transmit communication signals via a wireless air interface with, for example, a cellular network, a wireless local area network (WLAN), and/or another communication terminal (e.g., via a Bluetooth interface). Examples of mobile communication terminals include, but are not limited to, cellular phones, satellite phones, headsets (e.g., Bluetooth headset), laptop and/or palmtop computers configured to receive and/or transmit wireless communication signals.

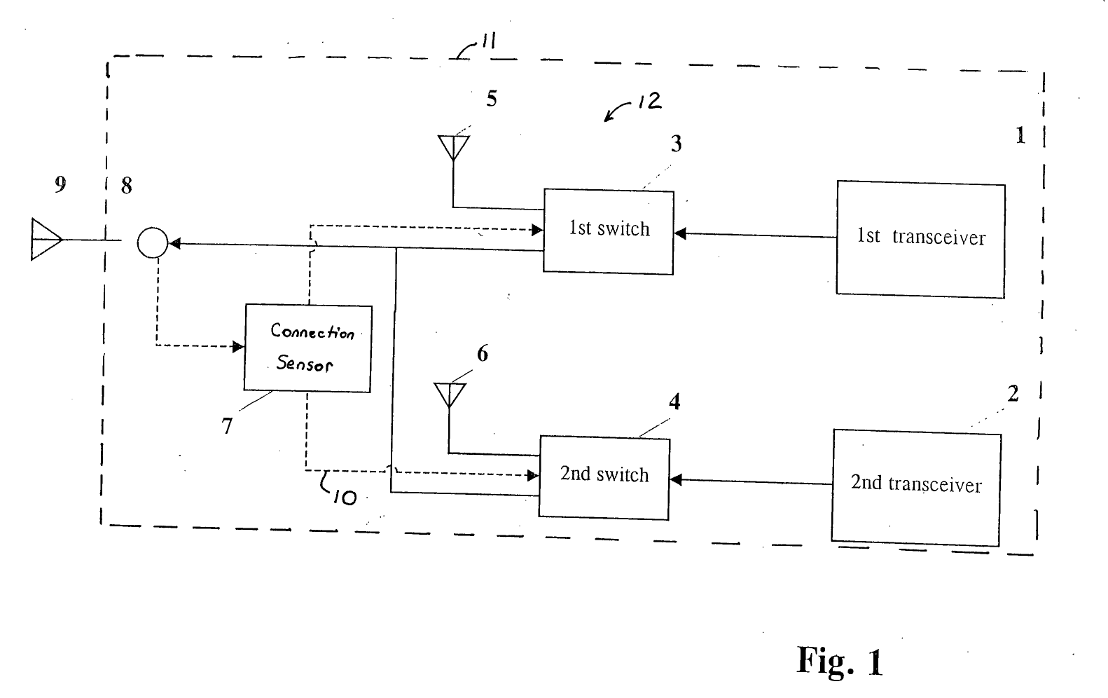

FIG. 1 illustrates an antenna switch structure 12 that can be used in a mobile communication terminal 11 according to various embodiments of the present invention. It is to be understood that although only some elements have been illustrated for purposes of explanation of various embodiments of the present invention, further elements, such as for baseband processing or a transceiver front end have omitted for the sake of clarity.

The antenna switch structure 12 includes a first transceiver 1 and a second transceiver 2. The first transceiver is configured to process signals of a first frequency band, such as, for example, GSM, DCS or UMTS. The second transceiver 2 is configured to process signals of a second frequency band, such as, for example, GSM, DCS or UMTS, but which are of a different frequency band than the signal processed by the first transceiver 1. The transceivers 1 and 2 are configured to receive and transmit signals. The transceivers 1 and 2 may include separate transmitters and receivers connected to baseband processor(s) (not shown).

A first antenna 5 is configured to transmit and receive wireless signals of the first frequency band, and a second antenna 6 is configured to transmit and receive wireless signals of the second frequency band. The first antenna 5 and the second antenna 6 may be internal antennas within the mobile communication terminal 11, and may be within the antenna switch structure 12. The antennas 5 and 6 may be located within the mobile communication terminal 11 remote from each other. By remotely locating the antennas 5 and 6 from each other, interference that may occur therebetween may be reduced.

The first antenna 5 may be directly coupled to the first transceiver 1 by a first switch 3. The second antenna 6 may be directly coupled to the second transceiver 2 by a second switch 4. The first switch 3 is configured to selectively connect the first transceiver 1 to the first antenna 5. The second switch 4 is configured to selectively connect the second transceiver 2 to the first antenna 6. Accordingly, communication signals may be selectively communicated between the first transceiver 1 and the first antenna 5 via the first switch 3, and between the second transceiver 2 and the first antenna 6 via the second switch 4.

The antenna switch structure 12 also includes a connector 8 that is configured to releasably connect a third antenna 9. The third antenna 9 may be at least partially external to the mobile communication terminal 11. The connector 8 may be used to connect calibration equipment and/or test equipment. The third antenna 9 is configured to receive and transmit signals of a plurality of frequency bands of one or more wireless communication standards, such as, for example, GSM, DCS or UMTS. The first switch 3 is configured to selectively connect the first transceiver 1 to the first antenna 5 or to the connector 8. The second switch 4 is configured to selectively connect the second transceiver 2 to the second antenna 6 or to the connector 8.

The first switch 3 and the second switch 4 may each include one or more switches, such as a combination of switches. The first switch 3 may not be limited to connecting the first transceiver 1 to either the first antenna 5 or to the connector 8, instead, it may also be configured to disconnect (i.e., isolate) the first transceiver 1 from both the first antenna 5 and the connector 8 (e.g., interrupt signal communication therebetween). The second switch 3 may be similarly not limited to connecting the second transceiver 2 to either the second antenna 6 or to the connector 8, instead, it may also be configured to disconnect (i.e., isolate) the second transceiver 2 from both the second antenna 6 and the connector 8 (e.g., interrupt signal communication therebetween).

The antenna switch structure 12 may also include a connection sensor 7. The connection sensor 7 is configured to detect when the third antenna 9 is connected to the connector 8 and to generate a connection indication signal 10 based thereon. The first and second switches 3 and 4 are configured to be controlled based on the connection indication signal 10 from the connection sensor 7. The first switch 3 is configured to selectively connect the first transceiver 1 to the first antenna 5 or to the connector 8 based on the connection indication signal 10. The second switch 4 is configured to selectively connect the second transceiver 2 to the second antenna 6 or to the connector 8 based on the connection indication signal 10. The connection sensor 7 may also be configured to control the first switch 3 to selectively isolate the first transceiver 1 from the first antenna 5 and the connector 8, and/or it may be configured to control the second switch 4 to selectively isolate the second transceiver 2 from the first antenna 6 and the connector 8.

Although only two transceivers and switches, have been shown in FIG. 1 for purposes of illustration, it is to be understood that embodiments of the present invention are not limited thereto. Instead, more than two transceivers may be used, where each transceiver may be coupled to an internal antenna by a respective switch. The switches may be controlled by one or more connection sensors to selectively connect each of the transceivers to an antenna, the connector, and/or to isolate the transceiver therefrom.

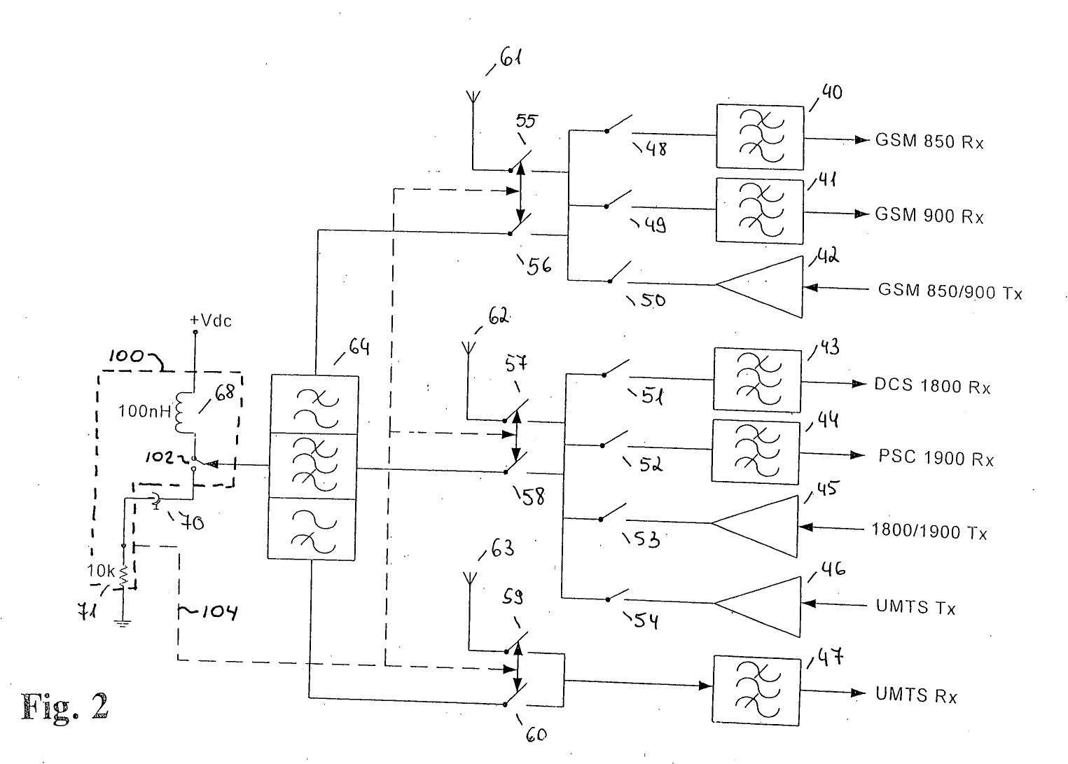

FIG. 2 is a block diagram of an antenna switch structure in accordance with various further embodiments of the present invention.

The transceivers 40 to 47 are configured to transmit or receive signals of different frequency bands relative to each other. In an exemplary embodiment, receive (Rx) filter 40 receives signals of the GSM 850 band, Rx filter 41 receives signals of the GSM 900 band, Rx filter 43 receives signals of the DCS 1800 band, Rx filter 44 receives signals of the PCS 1900 band and RX filter 47 receives signals of the UMTS band. In the exemplary embodiment, the transmit (Tx) power amplifier 42 transmits signals of the GSM 850 and 900 band, Tx power amplifier 45 transmits signals of the DCS 1800 and PCS 1900 band, and Tx power amplifier 46 transmits signals of the UMTS band.

Each of the transceivers 40 to 46 is connected to one of transceiver switches 48 to 54. Each of the switches 48 to 54 are configured to selectively connect and disconnect (i.e., isolate) the respective one of the transceivers 40 to 60 from associated antennas and further switches as will be described herein.

Three antennas 61 to 63, which may be internal to a mobile communication terminal, and which may be internal to the antenna switch structure, are configured to transmit and receive wireless signals of different frequency bands relative to each other. The transceivers 40 to 42 are connected to the first antenna 61, transceivers 43 to 46 are connected to the second antenna 62, and transceiver 47 is connected to the third antenna 63. The transceivers 40 to 42 are selectively connected to the first antenna 61 by respective ones of the transceiver switches 48 to 50. Accordingly, communication of signals between the transceivers 40 to 42 and the first antenna 61 can be selectively interrupted or allowed by the respective ones of the transceiver switches 48 to 50. The transceivers 43 to 46 are selectively connected to the second antenna 62 by respective ones of the transceiver switches 51 to 54.

Further, each of the antennas 61, 62, and 63 is connected to a respective one of antenna switches 55, 57, and 59. The antenna switches 55, 57, and 59 are configured to selectively connect and disconnect the associated one of the antennas 61, 62, and 63 from the other switches or transceivers and shown in FIG. 2. The transceivers 40 to 42 are connected to the first antenna 61 through transceiver switches 48 to 50 and antenna switch 55. The antenna switch 55 and the transceiver switches 48 to 50 are serially connected. For example, transceiver switch 48 may be operated to selectively connect and disconnect the transceiver 40 to the antenna switches 55 and 56. When the transceiver 40 is connected by the transceiver switch 48, the antenna switch 55 may be operated to selectively connect the transceiver 40 to the antenna 61, and/or the antenna switch 56 may be operated to selectively connect the transceiver 40 to a triplexer 64. Similarly, transceivers 43 to 46 are connected to the second antenna 62 through transceiver switches 51 to 54 and antenna switch 57. The transceiver switches 51 to 54 and antenna switch 57 are serially connected. Transceiver 47 is connected to the third antenna 63 by antenna switch 59.

A connector 70 is configured to releasably connect a mutiband antenna, which may be at least partially external to the mobile communication terminal, and may be at least partially external to the antenna switch structure. The multiband antenna may be configured to receive and transmit communication signals across more than one frequency band. The antenna switches 55, 57 and 59 may be configured to selectively disconnect (isolate) one or more of the antennas 61-63 when the multiband antenna is connected to the connector 70.

A switch 56 is configured to selectively connect the transceiver switches 48 to 50 to the triplexer 64. A switch 58 is configured to selectively connect the transceiver switches 51 to 54 to the triplexer 64. A switch 60 is configured to selectively connect the transceiver 47 to the triplexer 64.

The triplexer 64 is configured to combine the communication signal from the transceivers 40 to 47 and provide the combined signal to the connector 70, and a multiband antenna that may be connected thereto. The triplexer 64 is configured to communicate a communication signal from a multiband antenna, that is connected to the connector, to the transceivers 40 to 47.

The antenna switch structure also includes a connection sensor 100 that is configured to detect when the multiband antenna is connected to the connector 70, and to generate a connection indication signal 104 based thereon. The exemplary connection sensor 100 includes an inductor 68 that is connected between the connector 70 and a power supply voltage, and a resistor 71 that is connected between the connector 70 and ground. The inductor 68 may, for example, have a 100 mH inductance, and the resistor 71 may, for example, have a 10 k ohm resistance. When an antenna is connected to the connector 70, a mechanical contact 102 is closed and the connection indication signal 104 is formed by a voltage across the resistor 71.

The antenna switches 55 to 60 are configured to be controlled based on the connection indication signal 104. The antenna switches 55 to 60 may be configured to selectively connect the transceivers 40-47 to the antennas 61 to 63 when the connection indication signal 104 indicates that the multiband antenna is not connected to the connector 70, and may be configured to connect the transceivers 40-47 to the connector 70, via the triplexer 64, when the connection indication signal 104 indicates that the multiband antenna is connected to the connector 70

Because the antennas 61 to 63 may be optimized to communicate on different frequency bands relative to each other, the transceivers 40-47 may be also be optimized for the frequency bands of the associated antennas 61 to 63. Accordingly, the antennas 61 to 63 may be directly connected to the transceivers 40-47, through the switches, and which may reduce insertion losses and may increase efficiency by which signals are communicated therebetween. As was described herein, the antennas 61 to 63 may be remotely located relative to each other, which may further isolate the frequency bands of the communication signals generated therefrom, and may reduce the need for filtering of the communication signals. The connector 70 and/or the triplexer 64 may located outside the mobile communication terminal.

In the drawings and specification, there have been disclosed typical embodiments of the invention and, although specific terms are employed, they are used in a generic and descriptive sense only and not for purposes of limitation, the scope of the invention being set forth in the following claims.

1. An antenna switch structure for use in a mobile communication terminal, the antenna switch structure comprising:
a first transceiver that is configured to process signals of a first frequency band;
a second transceiver that is configured to process signals of a second frequency band;
a first antenna that is configured to transmit and receive wireless signals of the first frequency band;
a second antenna that is configured to transmit and receive wireless signals of the second frequency band;
a connector that is configured to releasably connect to a third antenna;
a first switch that is configured to selectively connect the first transceiver to the first antenna or to the connector; and
a second switch that is configured to selectively connect the second transceiver to the second antenna or to the connector.

2. The antenna switch structure of claim 1, wherein the connector is configured to releasably connect to the third antenna that is at least partially external to the mobile communication terminal.

3. The antenna switch structure of claim 1, wherein:
the first switch is directly connected between the first antenna and the first transceiver; and
the second switch is directly connected between the second antenna and the second transceiver.

4. The antenna switch structure of claim 1, wherein the first switch and the second switch comprise low insertion loss switches.

5. The antenna switch structure of claim 1, further comprising a connection sensor that is configured to detect when the third antenna is connected to the connector and to generate a connection indication signal based thereon, and wherein the first and second switches are configured to be controlled based on the connection indication signal from the connection sensor.

6. The antenna switch structure of claim 5, wherein the connection sensor comprises an inductor and a resistor connected to the connector.

7. The antenna switch structure of claim 6, wherein the connection indication signal is based on a voltage across the resistor.

8. The antenna switch structure of claim 5, wherein the first and second switches are configured to connect the first transceiver and the second transceiver, respectively, to the connector based on the connection indication signal indicating that the third antenna is connected to the connector.

9. The antenna switch structure of claim 5, wherein:
the first switch is configured to connect the first transceiver to the first antenna based on the connection indication signal indicating that the third antenna is not connected to the connector; and
the second switch is configured to connect the second transceiver to the second antenna based on the connection indication signal indicating that the third antenna is not connected to the connector.

10. The antenna switch structure of claim 5, wherein:
the first switch is configured to isolate the first transceiver from the connector and from the first antenna based on the connection indication signal; and
the second switch is configured to isolate the second transceiver from the connector and from the second antenna based on the connection indication signal.

11. A mobile communication terminal comprising:
a first transceiver that is configured to process signals of a first frequency band;
a second transceiver that is configured to process signals of a second frequency band;
a first antenna that is configured to transmit and receive wireless signals of the first frequency band;
a second antenna that is configured to transmit and receive wireless signals of the second frequency band;
a connector that is configured to releasably connect to a third antenna;
a first switch that is configured to selectively connect the first transceiver to the first antenna or to the connector; and
a second switch that is configured to selectively connect the second transceiver to the second antenna or to the connector, wherein the first antenna and the second antenna are remotely located from each other within the mobile communication terminal.

12. The mobile communication terminal of claim 11, wherein the connector is configured to releasably connect to the third antenna that is at least partially external to the mobile communication terminal.

13. The mobile communication terminal of claim 11, wherein:
the first switch is directly connected between the first antenna and the first transceiver; and
the second switch is directly connected between the second antenna and the second transceiver.

14. The mobile communication terminal of claim 11, wherein the first switch and the second switch comprise low insertion loss switches.

15. The mobile communication terminal of claim 11, further comprising a connection sensor that is configured to detect when the third antenna is connected to the connector and to generate a connection indication signal based thereon, and wherein the first and second switches are configured to be controlled based on the connection indication signal from the connection sensor.

16. The mobile communication terminal of claim 15, wherein the connection sensor comprises an inductor and a resistor connected to the connector.

17. The mobile communication terminal of claim 15, wherein the first and second switches are configured to connect the first transceiver and the second transceiver, respectively, to the connector based on the connection indication signal indicating that the third antenna is connected to the connector.

18. The mobile communication terminal of claim 15, wherein the first switch is configured to connect the first transceiver to the first antenna based on the connection indication signal indicating that the third antenna is not connected to the connector, and the second switch is configured to connect the second transceiver to the second antenna based on the connection indication signal indicating that the third antenna is not connected to the connector.
